(19) United States
(12) Patent Application Publication
(10) Pub. No.: US 2012/0187039 A1
(43) Pub. Date: Jul. 26, 2012

(54) Pleated Woven Wire Filter

(76) Inventor: Frank Lynn Bridges, Lake Charles, LA (US)

(21) Appl. No.: 13/188,466

(22) Filed: Jul. 22, 2011

Related U.S. Application Data
(63) Continuation-in-part of application No. 12/197,840, filed on Aug. 25, 2008, now abandoned.
(60) Provisional application No. 60/968,532, filed on Aug. 28, 2007.

(51) Int. Cl. B01D 27/06

(52) U.S. Cl. 210/457

(57) ABSTRACT

A removable, reusable, pleated woven wire filter for removing particulate material from a heavy coker gas oil process stream. The filter comprises: (a) a perforated core; (b) a pleated woven wire filter media wrapped around the perforated core, the filter media having spaced apart pleats and an external filter media surface comprising the external peaks of the pleats; (c) a stainless steel flattened expanded metal shroud adjacent to and encircling the external peaks; and (d) top and bottom end caps connected to the stainless steel flattened expanded metal shroud, and sealed against top and bottom ends of the filter media with a stainless steel adhesive sealant rated at 2,000 degrees Fahrenheit. The process stream operates between 300 and 800 degrees Fahrenheit, and between 150 psig and 500 psig. The filter can withstand a backwash purge pressure from 100 psig to 200 psig.

### CROSS-REFERENCES TO RELATED APPLICATIONS

This patent application is a continuation-in-part of patent application Ser. No. 12/197,840, filed Aug. 25, 2008, entitled “Pleated Woven Wire Filter”, and listing as the inventor Frank Lynn Bridges. This continuation-in-part patent application also claims the benefit of provisional patent application Ser. No. 60/968,532, filed Aug. 28, 2007, entitled “Pleated Woven Wire Filter”, and listing as the inventor Frank Lynn Bridges.

### STATEMENT REGARDING FEDERALLY SPONSORED RESEARCH OR DEVELOPMENT

None.

### THE NAMES OF THE PARTIES TO A JOINT RESEARCH AGREEMENT

None.

### INCORPORATION-BY-REFERENCE OF MATERIAL SUBMITTED ON A COMPACT DISC.

None.

### BACKGROUND OF THE INVENTION

(1) Field of the Invention

The invention relates to a back-washable filter for use in petrochemical processes involving corrosive high temperature liquid or gas streams with high concentrations of solids wherein the filter requires frequent backwashing.

(2) Description of the related art

U.S. Pat. No. 6,986,842 (“the Bortnik patent”), which is incorporated herein by this reference, discloses a fluid filter element having a pleated filter media with spaced apart pleats, an external filter media surface comprising the external peaks of the pleats, and a flexible foam filter media sleeve in contact with and extending between the pleats of the peaks of the external filter media surface. The filter media sleeve maintains the spacing between the external peaks of the pleats of the pleated filter media. The pleated filter media is for fluid applications and includes fragile material media layers between wire meshes, but the patent states that the number of media layers is “typically from 1-10 layers” (Column 3, lines 64-65). The Bortnik patent does not disclose means for preventing the expansion of the pleated filter media radially against the filter media sleeve during a backwash cycle, does not disclose means for sealing between the pleats and the ends of the filter, does not disclose using only a single layer of pleated woven-wire as a filter media, and discloses no a) optimal number of pleats to the circumference of the cylinder, b) optimal radial depth of each pleat, and c) optimal axial length of the pleats.

U.S. Pat. No. 4,786,670 (the “Tracey” patent), which is incorporated herein by this reference, discloses a compressible non-asbestos high-temperature sheet material usable for gaskets. U.S. Pat. No. 5,376,278 (the “Salem” patent), which is incorporated herein by this reference, discloses a filter used in a process vessel in a nuclear power generating plant; that is, a filter and a method for separating charged particles from a liquid stream. U.S. Pat. No. 5,795,369 (the “Taub” patent), which is incorporated herein by this reference, discloses a fluted filter media for a fiber bed mist eliminator, including “a layer of fluted filter media 48 and a support structure. The support structure preferably includes an inner cage 50, and an outer cage 52.” U.S. Pat. No. 6,962,256 (the “Nguyen” patent), which is incorporated herein by this reference, discloses a plastic molded center tube assembly.

Most of the existing reusable back-washable filters are offered in small diameters with limited surface areas. Thus a user must install large quantities of such filters in a single pressure vessel, in order to accommodate the high flow rates and heavy contaminant loadings associated with industrial process streams. Due to the material composition and design structure of most of such filters, the flow rates of known liquids and gases through those filters are low in relation to their surface area. Available gasket materials for sealing the filters are limited because the gaskets must survive high temperatures and corrosive chemicals. Most back-washable filters contain multiple filter elements, as in the Bortnik patent. Such multi-filter element filters suffer from at least two major deficiencies: 1) a limited surface area of the cylindrical designs which restrict flow in both the filtrate and backwash cycles, and 2) the backwash cycle is less efficient because the close proximity of filter elements in a multi-element filter results in the back-flushed contaminant collecting on the adjacent filter elements, and thereby increasing the backwash cycle time.

In light of the foregoing, a need remains for a reusable back-washable filter for use in petrochemical processes involving corrosive high temperature liquid or gas streams with high concentrations of solids wherein the filter requires frequent backwashing. More particularly, a need still remains for a reusable back-washable filter having a) means to keep the filter from radially expanding during a backwash cycle, b) means for sealing between the pleats and the ends of the cylinder containing the pleated woven-wire, c) optimized number of pleats to the circumference of the cylinder, d) optimized radial depth of each pleat, and e) optimized axial length of the pleats.

### BRIEF SUMMARY OF THE INVENTION

A removable, reusable, pleated woven wire filter for removing particulate material from a heavy coker gas oil process stream, the filter capable of withstanding a backwash purge pressure, the process stream containing asphaltenes, heavy catalytic-cracked petroleum distillates, catalytic-cracked petroleum clarified oils, residual heavy petroleum coker gas oil, vacuum gas oil, naptha, coke fines, H2S, Sulphur, Butane, Butene, and Chrysene, the filter comprising: (a) a perforated core; (b) a pleated woven wire filter media wrapped around the perforated core, the filter media having spaced apart pleats and an external filter media surface comprising the external peaks of the pleats; (c) a stainless steel flattened expanded metal shroud adjacent to and encircling the external peaks; and (d) top and bottom end caps connected to the stainless steel flattened expanded metal shroud, and sealed against top and bottom ends of the filter media with a stainless steel adhesive sealant rated at 2,000 degrees Fahrenheit, wherein the process stream operates between 300 and 800 degrees Fahrenheit, and between 150 psig and 500 psig, and the backwash purge pressure varies from 100 psig to 200 psig.

In another feature of the invention, a required square footage of filter media, determined by flow rate calculations for the given process, is divided by a number between 33 and 34 to determine the inside diameter of the perforated core.

In still another feature of the invention, the filter media consists of: a) an inner layer of woven wire metal mesh; b) a middle layer of stainless steel micronic filter cloth; and c) an outer layer of woven wire metal mesh, wherein the inner and outer layers support the filter cloth.

### BRIEF DESCRIPTION OF THE SEVERAL VIEWS OF THE DRAWINGS

FIG. 1 is a side view of the filter of the present invention in a typical process vessel.

FIG. 2 is a perspective view of the filter.

FIG. 3 is a perspective view of a first outer support structure for the filter.

FIG. 4 is a side view of part of a second outer support structure for the filter.

FIG. 5 is a perspective view of an inner support structure for the filter.

FIG. 6 is a side view of the filter showing its supporting structures and its inner core.

FIG. 7 is a plan view of the top of the outer support structure for the filter.

FIG. 8 is a plan view of the bottom of the outer support structure for the. filter.

FIG. 9 shows both plan and elevation views of the two ends of the outer and inner support structures for the filter.

FIG. 10 shows the filter media, of the filter of the present invention, attached to the perforated core.

FIG. 11 shows the top end cap of the filter.

FIG. 12 shows the bottom end cap of the filter.

FIG. 13 shows the top end cap connected to the round bar tie rods that connect the bottom end cap to the top end cap.

FIG. 14 shows the bottom end cap attached by the round bar tie rods to the top end cap.

FIG. 15 shows an outer support structure 41, as a stainless steel flattened expanded metal shroud.

FIG. 16 shows one of the diamond configurations that comprise the support structure 41.

### DETAILED DESCRIPTION OF THE INVENTION

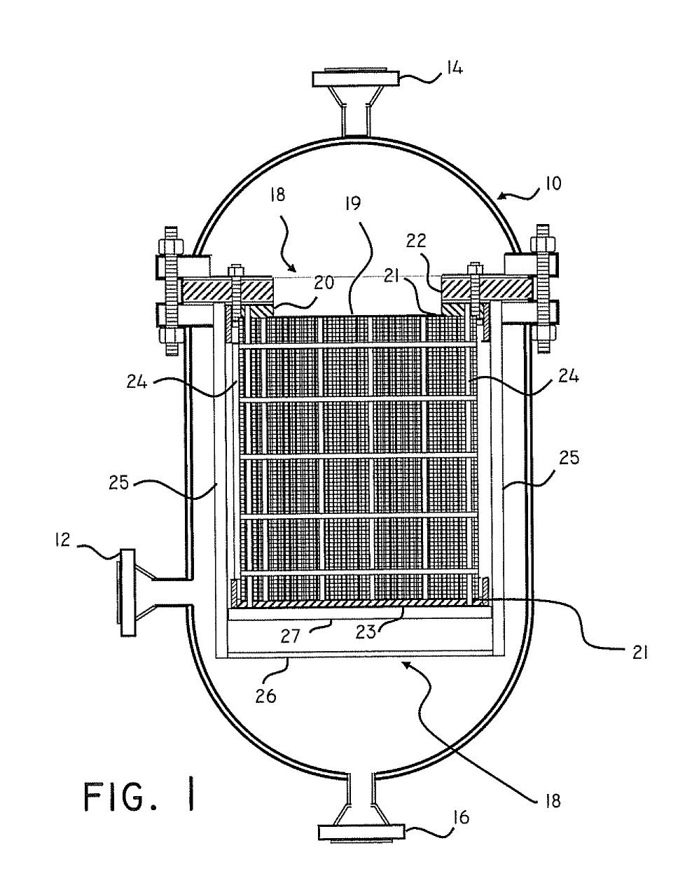

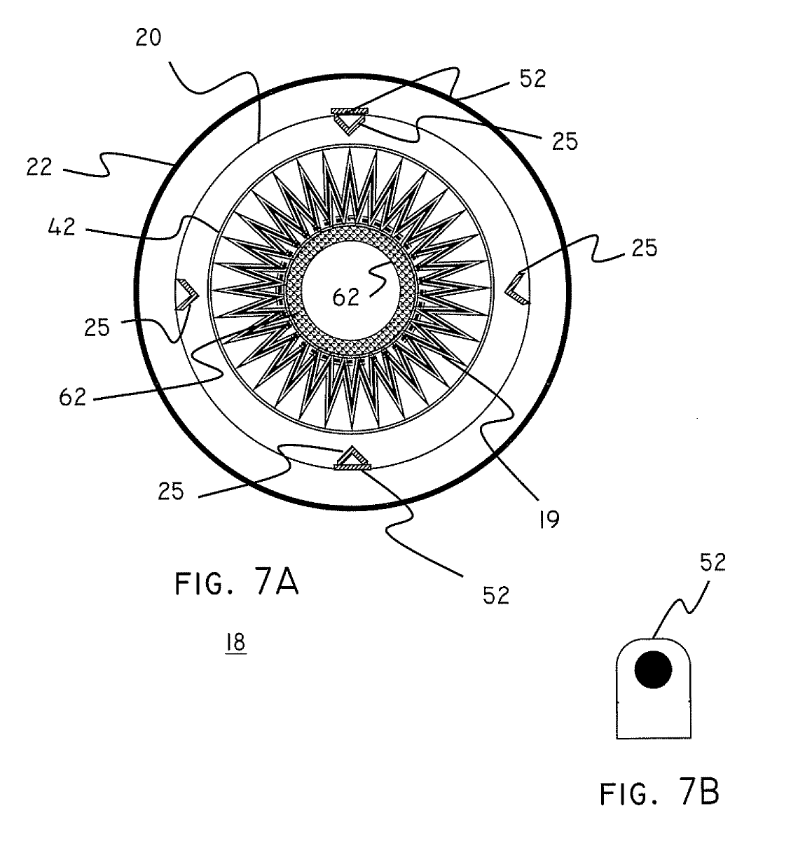

In FIG. 1, a typical process vessel 10 contains an inlet nozzle 12, an outlet nozzle 14, a backwash nozzle 16, and a filter 18, built according to the present invention. Dirty fluid enters the process vessel 10 through the inlet nozzle 12, and flows from outside of the filter 18, through a filter media 19, through a top end cap 20, and through a top flange plate 22, exiting through the outlet nozzle 14. During backwashing, liquid flows into the outlet nozzle 14, through the filter media 19, out through the bottom end cap 23, and out through the backwash nozzle 16. The filter media 19 comprises three layers of pleated wire, consisting of an inner layer of woven wire metal mesh, a middle layer of stainless steel micronic filter cloth, and an outer layer of woven wire metal mesh. In the preferred embodiment, the stainless steel micronic filter cloth is the twilled dutch weave manufactured by Southwestern Wire Cloth, having a mesh count per inch of 165×1400. The inner and outer layers function as a support structure for the micronic filter cloth. A stainless steel adhesive sealant 21, rated at 2,000 F, functions as a fluid containment barrier and structural reinforcement bond connecting a perforated core 62 (shown in FIG. 7a), the filter media 19, the end caps 20, 23, and tie rods 24. The sealant 21 seal the ends of the filter media 19 against the top end cap 20 and the bottom end cap 23. The sealant 21 can endure temperatures up to 2,000 F, and has the flexibility and compressibility to accept the rigid wire members of the filter media 19, and provides a positive seal against fluid by-pass, while offering a high operating temperature of 2,000 degrees Fahrenheit. In the preferred embodiment, the sealant 21 is the DURABOND brand, sold by Cotronics Corp., Brooklyn, N.Y.

Eight cap tie rods 24 are vertical round bar rods with threaded ends which attach to the top end cap 20 and the bottom end cap 23 in pre-drilled and threaded holes, and thus keep pressure against the ends of the filter media 19. Each cap 20 and 23 has a two-inch lip. Angle iron legs 25 are welded to the top flange plate 22, to a bottom ring 26, and to an angle iron horizontal support 27. The top flange plate 22 is sized to fit the particular process vessel 10. Sixteen bolts 28 connect the top flange plate 22 to the top end cap 20, with a Flexitallic® brand gasket 29 located between the top flange plate 22 and the top end cap 20. Once the filter assembly is attached to the top flange plate 22, the angle iron horizontal support 27 is welded into position immediately adjacent to the underside of the bottom end cap 23 to provide additional seal support pressure for the wire fins of the filter media 19 during operation, when vibration and movement could occur during the filter and backwash cycles.

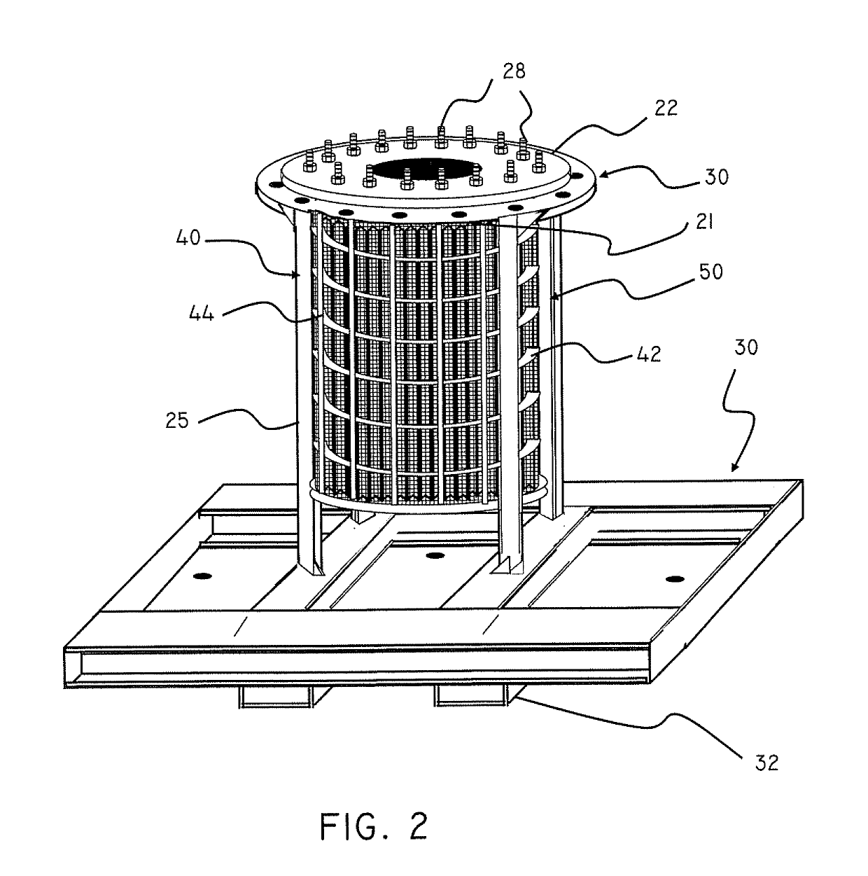

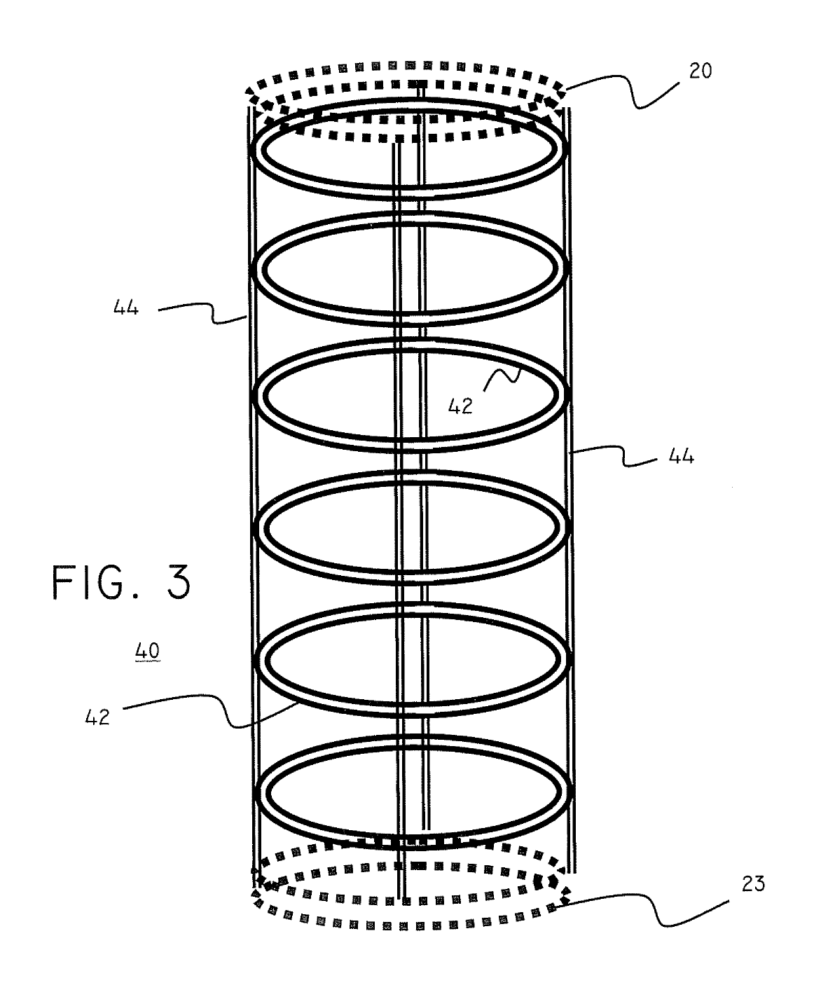

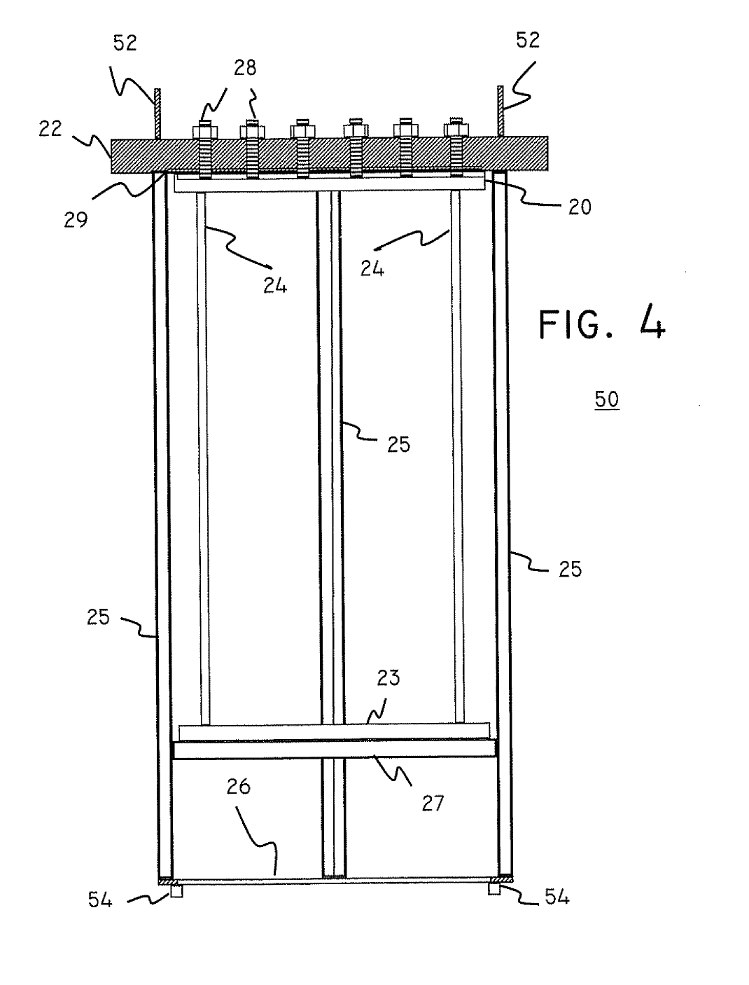

Referring now to FIG. 2, the filter 18 is ideally mounted on a shipping skid 30 for transportation to the location of a process vessel 10. The shipping skid 30 includes insert points 32 for a forklift. The filter media 19 has two separate outer support structures, shown in more detail in FIG. 3 and FIG. 4, connected to it.

Referring now to FIG. 3, in one embodiment an outer support structure 40 supports the filter media 19 during backwashing. It does not connect to the top and bottom end caps 20, 23, which are shown in dotted lines merely to show the location of the outer support structure 40. The outer support structure 40 includes a series of metal horizontal bands 42 that are welded to four vertical metal flat bar supports 44. Ideally, the horizontal bands are spaced about a foot apart. The outer support structure 40 minimizes the chances of pleat deformation and woven wire deterioration of the filter media 19 from abrasion during pleat movement.

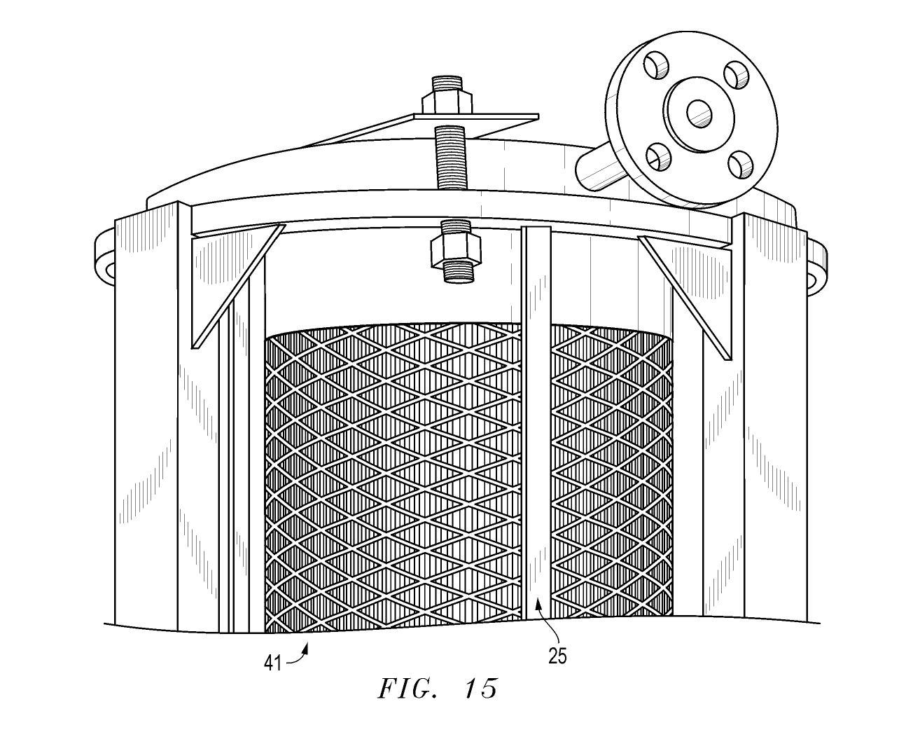

Referring now to FIG. 15, in the preferred embodiment, an outer support structure 41 is a stainless steel flattened expanded metal shroud with 80% open area. This expanded metal outer shroud provides improved backwash support for the filter media 19. The structure 41 includes the angle iron legs 25.

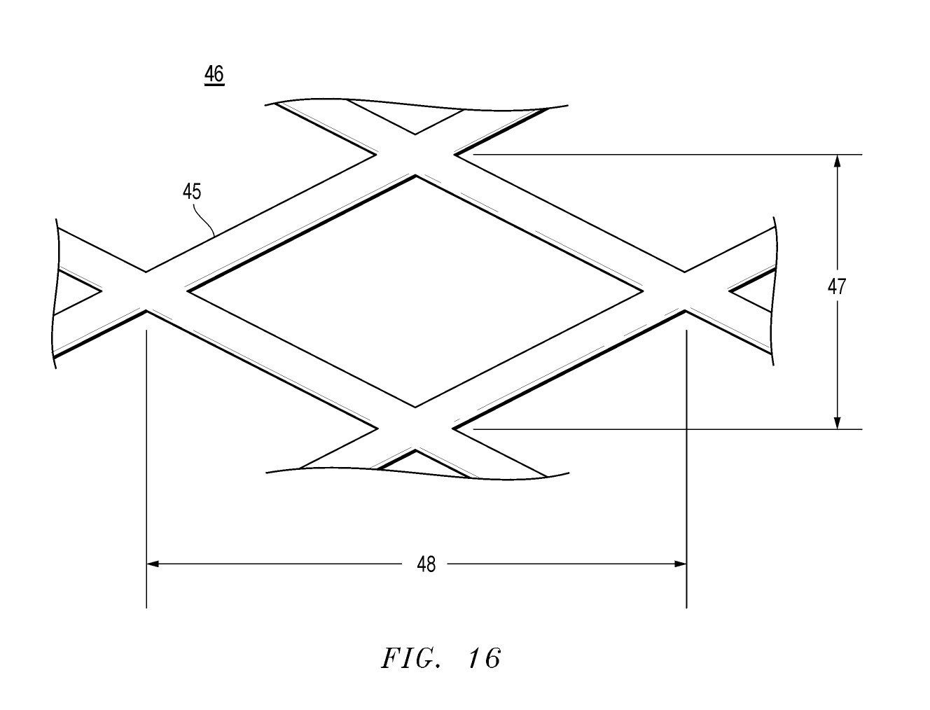

Referring now to FIG. 16, the support structure 41 further comprises a series of diamond configurations 46 made of strands 45. Each diamond configuration 46 has a height 47 and a width 48. In the preferred embodiment, the height 47 is 1.33 inches, and the width 48 is 3.15 inches. This results in an opening for each diamond configuration having a height of 1.062 inches, and a width of 2.75 inches. The thickness of each strand 45 of the support structure 41 is 0.050 inches.

Referring now to FIG. 4, a second outer support structure 50 includes the top flange plate 22, with two lifting lugs 52 welded to it. The two lifting lugs 52 aid in lifting the heavy filter 18 into and out of the process vessel 10. The outer support structure 50 also includes the bottom ring 26, which has four one-inch risers 54 welded to it, to keep the entire filter assembly off the ground during manufacturing. As noted with reference to FIG. 1, the outer support structure 50 includes eight cap tie rods 24 threaded into the top end cap 20 and the bottom end cap 23, and angle iron legs 25 welded to the top flange plate 22, to a bottom ring 26, and to an angle iron horizontal support 27.

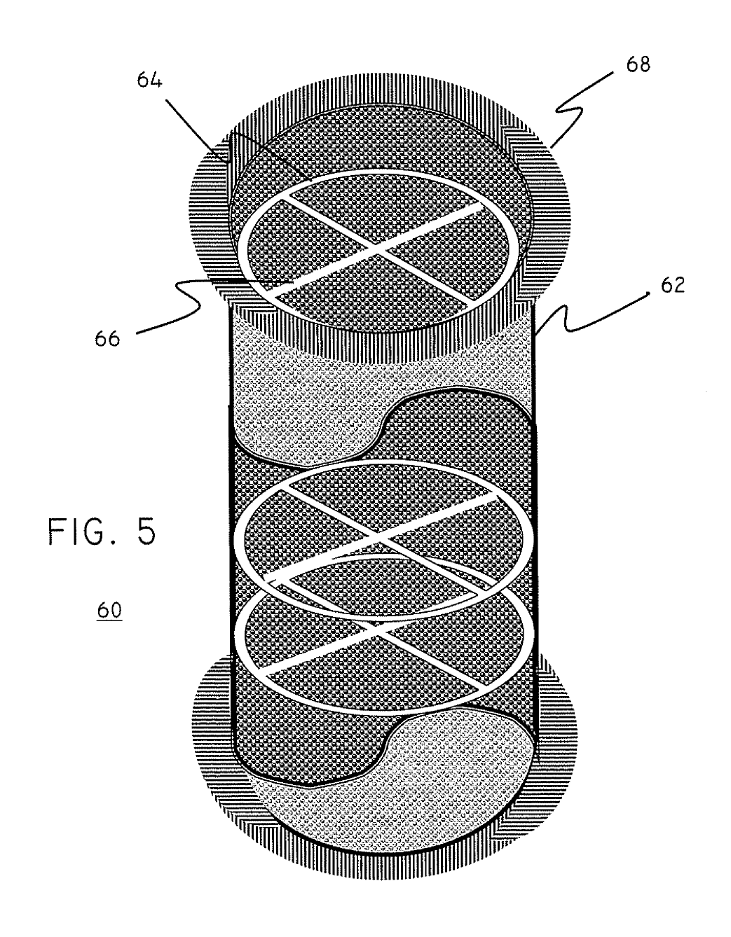

Referring now to FIG. 5, an inner support structure 60 includes a perforated core 62 that contains rings 64 with cross-braces 66. At the top of the core 62 are clips 68 that are bent over to hold in place the filter media 19.

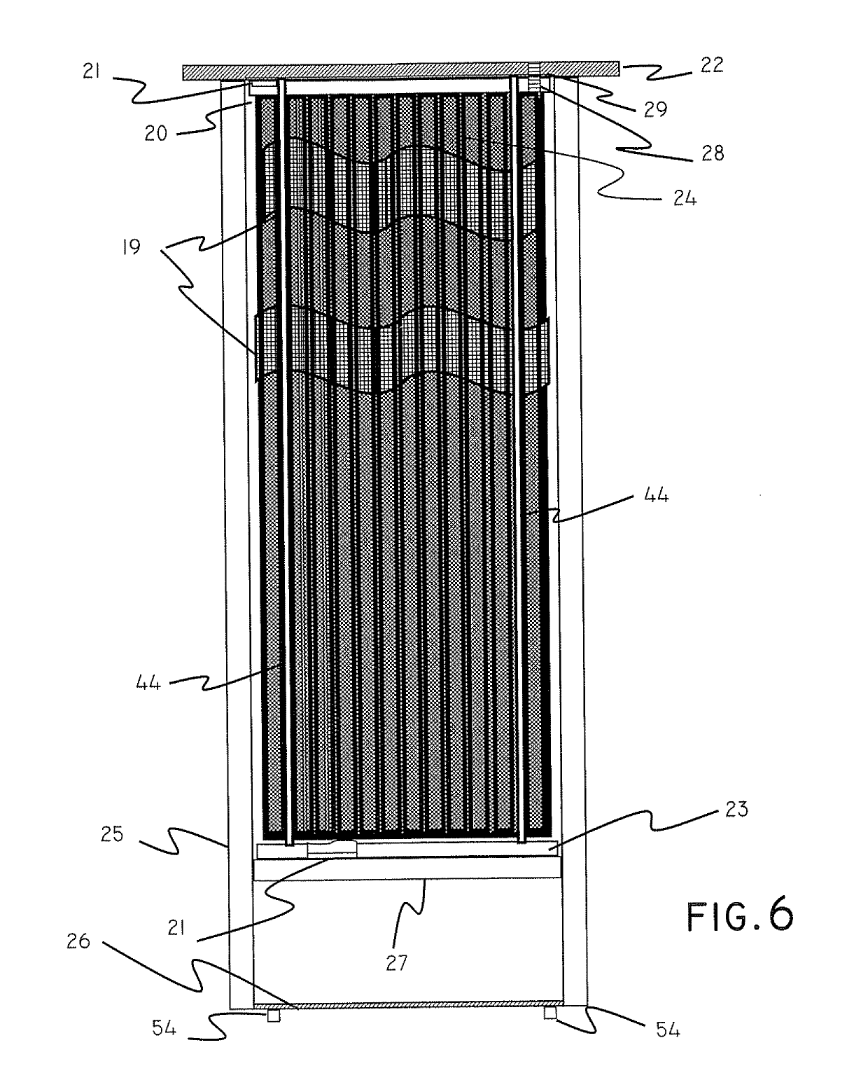

Referring now to FIG. 6, the second outer support structure 50 of FIG. 4 is shown together with the pleated woven wire filter media 19.

Referring now to FIG. 7A, a top plan view of the filter 18 shows the perforated core 62 surrounded by the pleated woven wire filter media 19 surrounded by the horizontal bands 42. Also shown is the top end cap 20, the top flange plate 22, and the lifting lugs 52, one of which is shown in a separate side view in FIG. 7B.

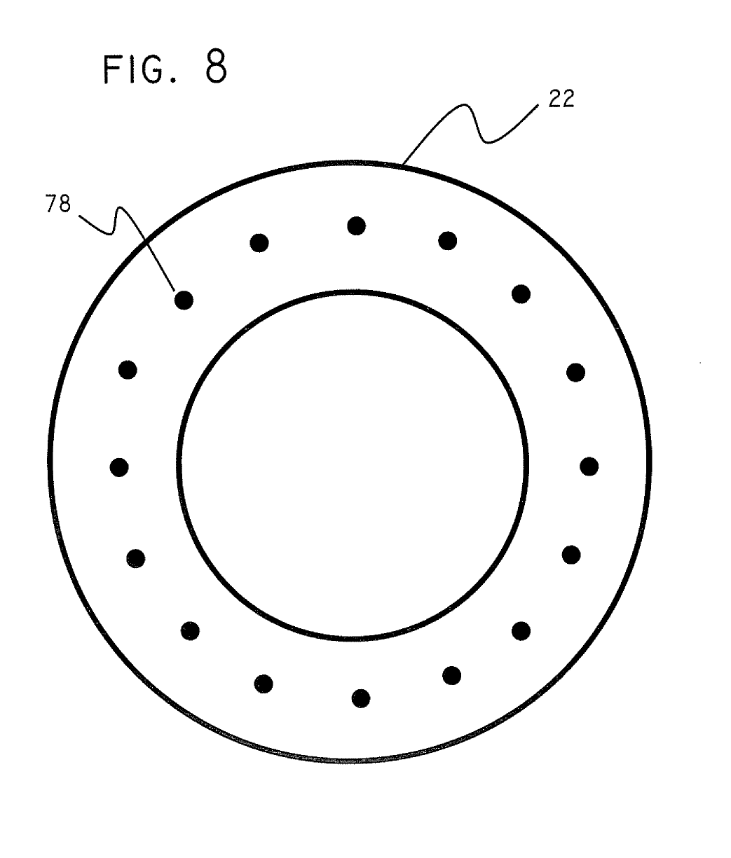

Referring now to FIG. 8, the top flange plate 22 includes threaded bolt holes 78 that are machined into the top flange plate 22 to fasten the top end cap 20 to the plate 22 with the B-7 stud bolts 28.

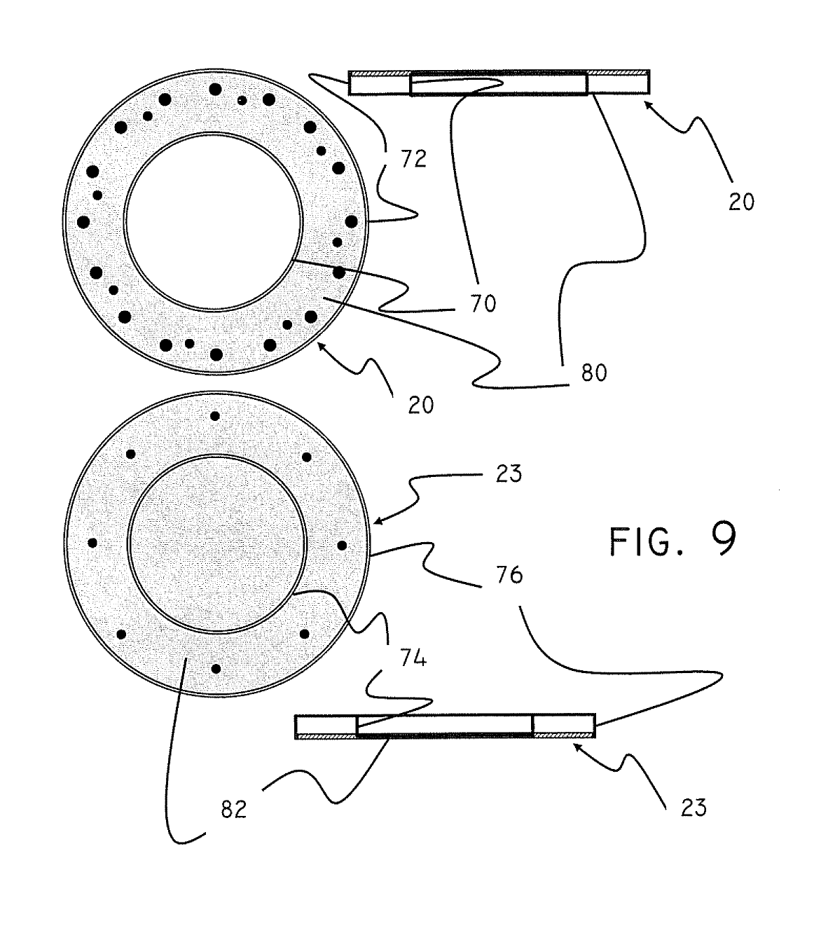

Referring now to FIG. 9, the top end cap 20 includes an inner perimeter lip ring 70, an outer perimeter lip ring 72, and a one-inch thick metal plate 80. The bottom end cap 23 includes an inner perimeter lip ring 74, an outer perimeter lip ring 76, and a three-quarter-inch thick metal plate 82.

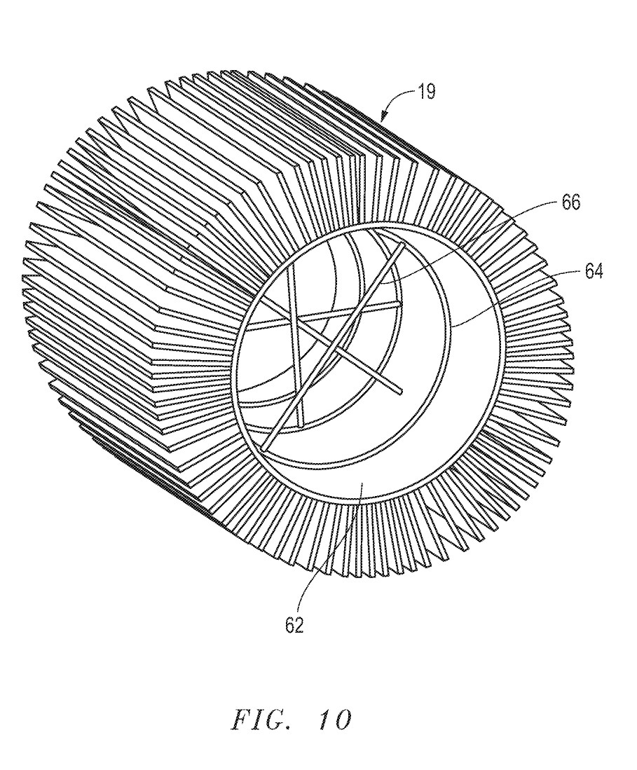

Referring to FIG. 10, the filter media 19 is shown attached to the perforated core 62, which contains rings 64 with cross-braces 66, as also shown in FIG. 5.

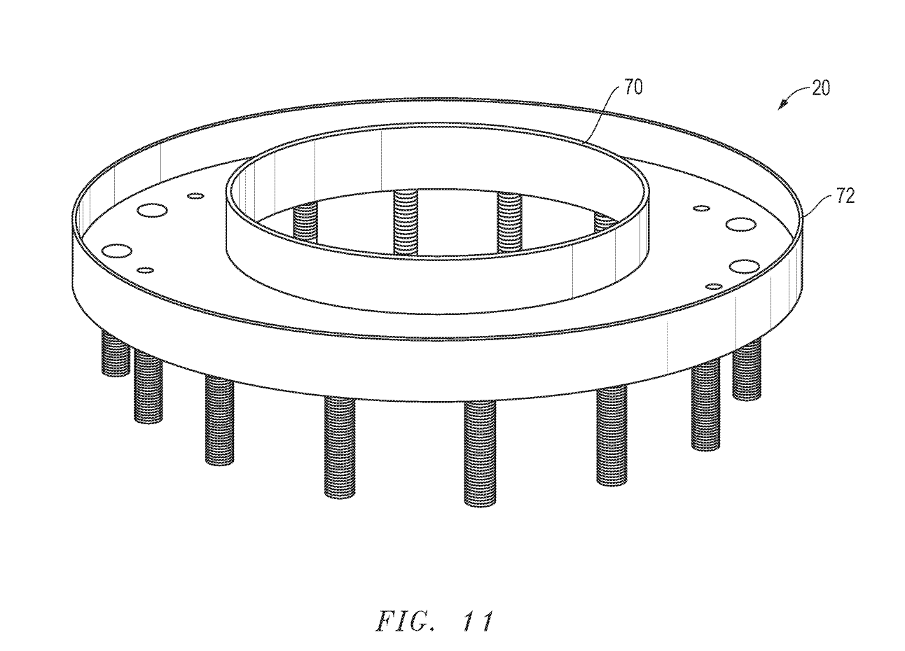

Referring to FIG. 11, the top end cap 20 includes the inner perimeter lip ring 70 for aligning the perforated core 62, the outer perimeter lip ring 72, and the stud bolts 28 that fasten the top end cap 20 to the top flange plate 22.

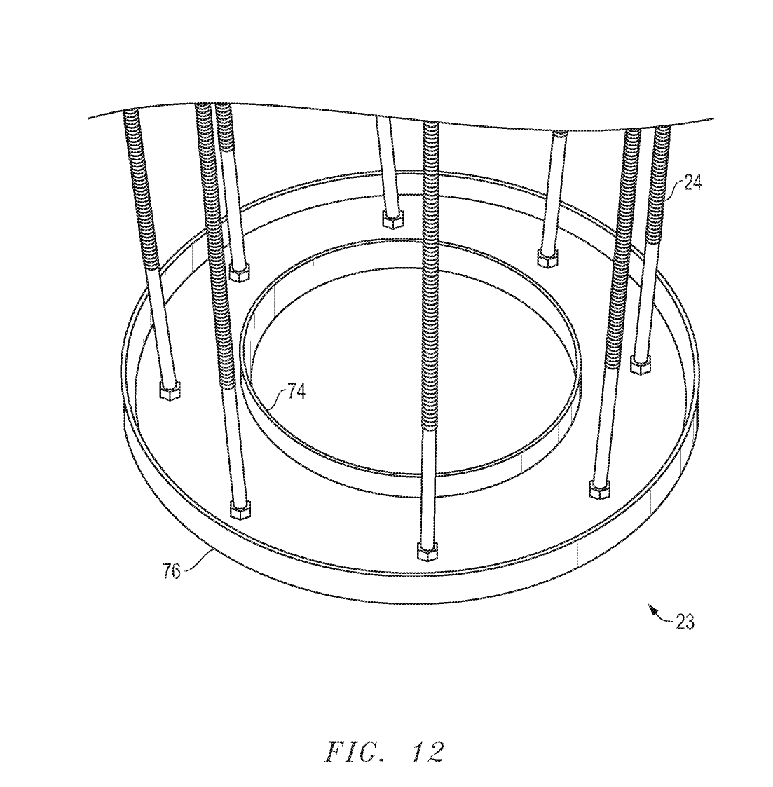

Referring to FIG. 12, the bottom end cap 23 includes the inner perimeter lip ring 74 for aligning the perforated core 62, the outer perimeter lip ring 76, and the round bar tie rods 24 that connect the bottom end cap 23 to the top end cap 20.

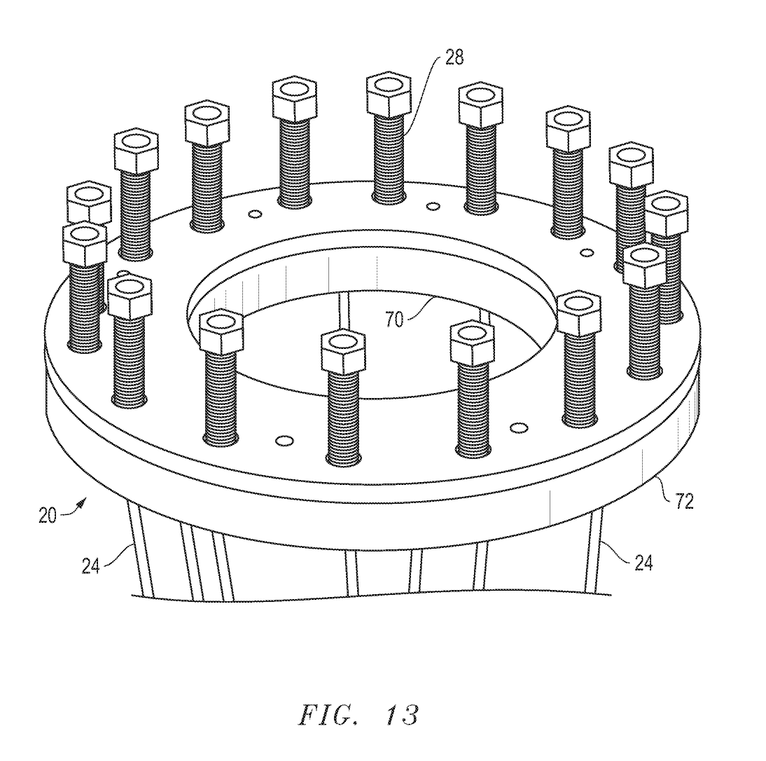

Referring to FIG. 13, the top end cap 20, including the inner perimeter lip ring 70, the outer perimeter lip ring 72, and the stud bolts 28, is shown connected to the round bar tie rods 24 that connect the bottom end cap 23 to the top end cap 20.

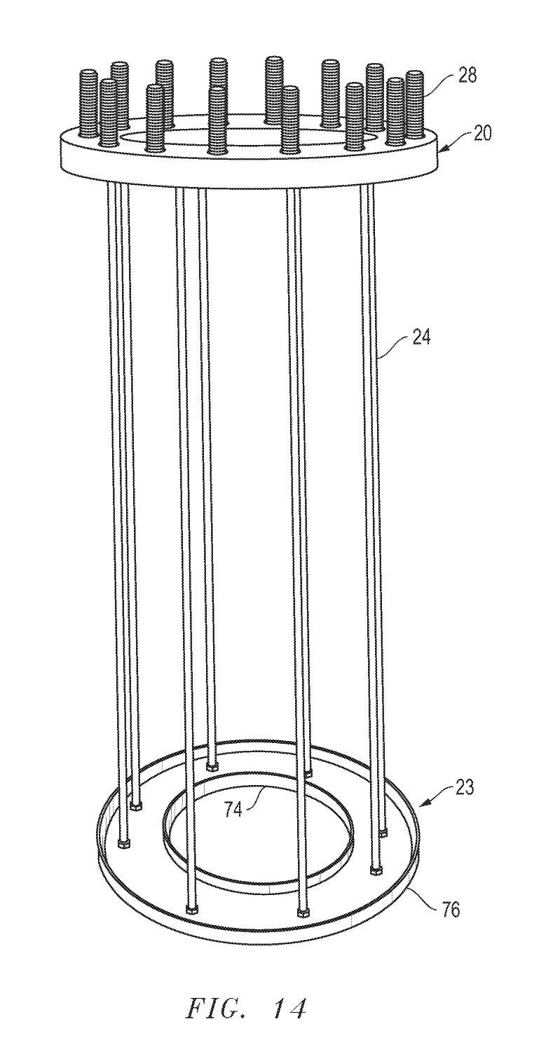

Referring to FIG. 14, the bottom end cap 23, with the inner perimeter lip ring 74 and the outer perimeter lip ring 76, is shown attached by the round bar tie rods 24 to the top end cap 20.

According to the manufacturing process of the present invention, the process has been optimized to calculate the proper size of a filter needed for a given process. With a known process stream fluid specification (including but not limited to specific gravity, viscosity, required micron retention, allowable pressure drop, line size, operating pressure, and operating temperature) and a required flow rate, the required surface area of the filter media 19 can be obtained based on manufacturers' efficiency ratings for the specific micron rated metal woven wire media that will satisfy process conditions.

The following definitions apply for the three equations listed below:

D is the inside diameter of the perforated core 62. On a retrofit application, D must not exceed thirteen inches less than the inside diameter of the existing process vessel. This maximum D allows a four-inch pleat depth, plus five inches for end cap outside diameter allowance and vessel wall spacing factors.

C is the circumference in inches of the perforated core 62.

P is the pleat depth in inches of the filter media 19. The maximum pleat depth for micron rated metal woven wire is four inches.

N is the number of pleats per inch of the circumference of the perforated core 62. The maximum number of pleats for micron rated metal woven wire is four pleats per inch of circumference.

H is the pleat height. The maximum pleat height for micron rated metal woven wire is forty-eight inches.

S is the surface area of the filter media 19.

C=πD

4C=N

(2P)NH=S

D affects C by a factor of pi (3.14159), which in the next step affects N by a factor of 4. When this factor (now 12.5664) is applied to P, which by limitation is a maximum of 8, then the figure of 100.53 becomes a constant against H, which (again by limitation) is 48. The new formula constant is now 4,825.4976. This figure represents square inches, so when divided by 144, the number 33.51 (in square feet) is obtained as the surface area constant.

Thus, the selection of the size of the inside diameter of a process vessel 10 depends on the inside diameter of the perforated core 62. As an example, if flow rate calculations dictate a required square footage of stainless steel micronic filter cloth to be 1,000 square feet, then 1,000 sq. ft divided by 33.51 yields a 29.84 inch inside diameter for the perforated core 62. When this figure is added to the thirteen-inch minimum clearance requirement for the process vessel 10, the minimum inside diameter of the process vessel 10 is 42.84 inches.

Conversely, for a known size of a process vessel 10, one deducts thirteen inches from the inside diameter of the process vessel 10, and then multiplies that figure by 33.51. As an example, if the process vessel 10 has an inside diameter of thirty-six inches, this would factor as a twenty-three inch inside diameter of the perforated core 62, which when multiplied by 33.51 would equal 770.73 square feet of surface area available, assuming that the vertical clearance in the process vessel 10 will accommodate the height of the filter media 19. When the available surface area is known, then a maximum flow rate can be established for the vessel with inlet and outlet nozzle limitations being the only other factors.

1. A removable, reusable, pleated woven wire filter for removing particulate material from a heavy coker gas oil process stream, the filter capable of withstanding a backwash purge pressure, the process stream containing asphaltenes, heavy catalytic-cracked petroleum distillates, catalytic-cracked petroleum clarified oils, residual heavy petroleum coker gas oil, vacuum gas oil, naptha, coke fines, H₂S, Sulphur, Butane, Butene, and Chrysene, the filter comprising:
a. a perforated core;
b. a pleated woven wire filter media wrapped around the perforated core, the filter media having spaced apart pleats and an external filter media surface comprising the external peaks of the pleats;
c. a stainless steel flattened expanded metal shroud adjacent to and encircling the external peaks, and
d. top and bottom end caps connected to the stainless steel flattened expanded metal shroud, and sealed against top and bottom ends of the filter media with a stainless steel adhesive sealant rated at 2,000 degrees Fahrenheit,
wherein the process stream operates between 300 and 800 degrees Fahrenheit, and between 150 psig and 500 psig, and the backwash purge pressure varies from 100 psig to 200 psig.

2. The filter of claim 1, wherein a required square footage of filter media, determined by flow rate calculations for the given process, is divided by a number between 33 and 34 to determine the inside diameter of the perforated core.

3. The filter of claim 2, wherein the filter media consists of:
a. an inner layer of woven wire metal mesh;
b. a middle layer of stainless steel micronic filter cloth; and
c. an outer layer of woven wire metal mesh;
and wherein the inner and outer layers support the filter cloth.

4. The filter according to any of claims 1-3, wherein spaced-apart clips at each end of the perforated core are bent radially outward and then inward, squeezing the filter media against the perforated core.
